(19) United States
(12) Patent Application Publication
(10) Pub. No.: US 2021/0388617 A1
(43) Pub. Date: Dec. 16, 2021

(54) ROOFING MEMBRANE ACCESSORY

(71) Applicant: COOPER-STANDARD AUTOMOTIVE, INC., Novi, MI (US)

(72) Inventors: Krishnamachari GOPALAN, Troy, MI (US); Robert J. LENHART, Fort Wayne, IN (US); Gending JI, Canton, MI (US); Jacob La FOREST, Milan, MI (US)

(21) Appl. No.: 17/349,368

(22) Filed: Jun. 16, 2021

Related U.S. Application Data
(60) Provisional application No. 63/039,741, filed on Jun. 16, 2020.

(51) Int. Cl. E04D 5/10; C08K 3/26; C08F 210/16; C08L 51/00

(52) U.S. Cl. CPC E04D 5/10; C08K 3/26; C08F 236/20; C08L 51/003; C08K 2003/265; C08F 210/16

(57) ABSTRACT

A roofing accessory is disclosed includes an elastomeric layer including non-crosslinked elastomeric material having a composition including: (A) 100 PHR of a base polymer including ethylene propylene diene monomer (EPDM) having a sum of ethylidene norbornene (ENB) content, vinyl norbornene (VNB) content, norbornadiene content, and 1,4 hexadiene content and/or dicyclopentadiene (DCPD) content from about 0 to 9 wt. %, (B) about 50 to 300 PHR of calcium carbonate; and (C) about 50 to 200 PHR of a dewaxed heavy paraffinic process oil(s). The accessory may further include a butyl-based layer adjacent to the elastomeric layer. The accessory may also include a protective layer configured as a liner, the protective layer arranged adjacent to the butyl-based layer such that the butyl-based layer is sandwiched between the first and protective layers. The accessory may have elongation at break of up to about 1800%.

### CROSS-REFERENCE TO RELATED APPLICATIONS

This application claims the benefit of U.S. provisional application Ser. No. 63/039,741 filed Jun. 16, 2020, the disclosure of which is hereby incorporated in its entirety by reference herein.

### TECHNICAL FIELD

The present disclosure pertains to a roofing membrane accessory and a process of making the same.

### BACKGROUND

Commercial roofing materials vary from tar-and-gravel roof to metals such as aluminum or corrugated galvanized steel to various rubber materials. The latter are used due to their long-lasting durability and versatility, but also a relatively simple installation and maintenance as well as better weatherability than other typical commercial roof coverings. The synthetic rubber roofing materials include various thermosets and thermoplastics. Because commercial roofing typically requires installation on low-slope buildings having a number of roofing features such as chimneys, a material compatible with a specific synthetic rubber needs to ensure water-proof connection between the feature and the synthetic rubber material, thermoplastic polyolefin compounds (TPO), and polyvinylchloride (PVC).

A synthetic rubber roofing material is usually applied as a sheet on relatively low-slope roofing structures. Low-slope roofs are defined as having a minimum slope of ¼ inch vertical to 12 inch horizontal or 2%, depending on the type of roofing material. Low-slope roofs may be also defined as having up to 3:12 pitch. In addition, the synthetic rubber roofing's application is feasible also on residential flat roof structures. Roofing installation typically involves application of a roofing material around and/or over various roofing features or structures such as chimneys, vents, ridges, skylights, and other protrusions form the roofing surface. The connection between a roofing structure and the roofing material needs to function as a seal, be waterproof, and prevent ingress of water, insects, particulate matter, and the like into the connection space.

The connection provided between the roofing structures and the synthetic rubber materials may be provided by an accessory. A roofing accessory may also be also used to seal the edges where roof panels meet one another. A roofing accessory may constitute or function with or as a ridge, flashing, hip, eave, fascia, gable, or drip edge.

Because the various synthetic rubber materials vary in their chemical composition as well as physical and mechanical properties, a roofing accessory needs to be tailored to cooperate with the synthetic rubber materials applied to the roof. The chemical composition of the synthetic rubber material thus typically determines its compatibility with other materials and contributes to the decision concerning which type of accessory should be used in combination with the particular roofing synthetic rubber.

While various roofing accessories have been developed, numerous challenges remain. First, a roofing accessory's desired degree of adhesion requires balancing several, sometimes competing factors. Adhesion is the tendency of different surfaces to stick together caused by various intermolecular forces. On one hand, the accessory needs to sufficiently adhere not only to the base synthetic rubber roofing material, but also to each structure the accessory will be connected with. The structures may include metal, masonry, polymers, and the like, and thus may vary in their material composition and properties. On the other hand, the accessory cannot have such a high degree of stickiness that the accessory's efficient and economical production and installation would be compromised. For example, the accessory should not adhere to the manufacturing equipment during production.

A high percentage of water leaks on low-slope roofing occurs at locations with compromised flashing, where the base roofing material ends or is interrupted. Hence, the adhesion of the accessory to the synthetic rubber material as well as the various roofing structures needs to be long lasting. After installation, the structure, integrity, and appearance of the accessory should be unchanged or undergo only minimal changes in time. The accessory should have no cracking, peeling, or other durability issues, and further be able to withstand environmental conditions, including the potential impact of hail, wind damage, or fire. Hence, the accessory should possess excellent weatherability and resistance towards temperature changes, humidity level fluctuations, UV radiation, and other weather-related factors.

Additionally, the accessory should match the synthetic rubber material's (the roofing membrane's) appearance including hue, value, and saturation as closely as possible for a visually appealing result.

Yet another requirement is the accessory's ability to stretch to accommodate varied shapes and contours of the structures discussed above and to fill and/or cover any gaps within the connection. The accessory thus should be pliable enough to wrap around irregular surfaces of various roofing structures without tearing or forming gaps. The pliability of the accessory further allows an installer to apply the accessory without exerting a large amount of force in stretching.

Fulfilling all of the above-named requirements has been a challenge. Various accessories have been developed, but they typically exhibit at least one drawback. For example, polyvinyl chloride (PVC) may be used as an accessory, but its adherence to synthetic rubber materials is problematic. For example, PVC material does not adhere to silane-grafted polyolefin elastomer compositions. Other materials may have better adhesion than PVC, but are problematic due to their inflexibility. Typical roofing materials also do not have sufficient pliability to contour irregular surfaces of various roofing structures. Additionally, typical roofing material is black in color, and as such visually not compatible with light-colored roofing materials.

Accordingly, there is a need for improved accessories for roofing applications.

### SUMMARY

It has now been unexpectedly discovered that non-crosslinked elastomeric material having a low content of diene units or fully saturated (no diene units), as further defined below, in combination with calcium carbonate, heavy paraffinic oils, and other optional components such as a silane-grafted component, may be used as a roofing accessory having desirable properties such as good flexibility, relatively low tensile strength, high elongation at break, maximum elongation. The non-crosslinked elastomeric material may be used as a first layer compatible with additional layers such as a butyl layer. Additionally, the roofing accessory can color match the base roofing material including white roofing.

In at least one embodiment, a roofing accessory is disclosed. The accessory may include an elastomeric layer including non-crosslinked elastomeric material having a composition including: (A) 100 PHR of a base polymer including ethylene propylene diene monomer (EPDM) with an ethylidene norbornene (ENB) content of about 0 to 9 wt. %; (B) about 50 to 300 PHR of calcium carbonate; and (C) about 50 to 200 PHR of a dewaxed heavy paraffinic process oil(s). The accessory may further include a butyl-based layer adjacent to the elastomeric layer. The accessory may also include a protective layer configured as a liner, the protective layer arranged adjacent to the butyl-based layer such that the butyl-based layer is sandwiched between the first and protective layers. The accessory may have elongation at break of up to about 1800%.

In an alternative embodiment, a roofing membrane accessory is disclosed. The accessory may include an elastomeric layer including non-crosslinked elastomeric material having a composition including: (A) about 120 to 180 PHR of an oil-extended base polymer including oil-extended EPDM having ethylidene norbornene (ENB) content of about 0 to 9 wt. %, wherein oil(s) are present in an amount of about 60 to 90 PHR, (B) about 50 to 300 PHR of calcium carbonate; and (C) about 50 to 200 PHR of a dewaxed heavy paraffinic process oil(s). The accessory may further include a butyl-based layer adjacent to the elastomeric layer. The accessory may also include a protective layer configured as a liner, the protective layer arranged adjacent to the butyl-based layer such that the butyl-based layer is sandwiched between the first and protective layers. The accessory may have elongation at break of up to about 1800%.

In another embodiment, a roofing membrane accessory is disclosed. The accessory may include a non-crosslinked elastomeric material having a composition including: (A) 120-180 PHR of an oil-extended base polymer including ethylene propylene diene monomer (EPDM) with an ethylidene norbornene (ENB) content of about 0 to 9 wt. %; (B) about 140 to 160 PHR of calcium carbonate; (C) about 80 to 100 PHR of a dewaxed heavy paraffinic process oil(s); and (D) about 10 to 40 PHR of a silane-grafted elastomer. The accessory is free of a crosslinking catalyst and curative. The accessory may have Mooney viscosity (1+4 at 100° C.) of about 10 to 60. The accessory may also include about 2 to 8 PHR of titanium dioxide.

In an alternative embodiment, a roofing accessory is disclosed. The roofing accessory may include 100 PHR of a base polymer including ethylene propylene diene monomer (EPDM) with an ethylidene norbornene (ENB) content of about 0 to 9 wt. %; about 50 to 300 PHR of calcium carbonate; about 50 to 200 PHR of a dewaxed heavy paraffinic process oil(s); and about 6 to 20 PHR of titanium dioxide. The accessory may have a colorimetric brightness value L* of about 96.5 to 98 and tone value b* of about 1.5 to 2.5, measured according to DIN 55983.

### BRIEF DESCRIPTION OF THE DRAWINGS

FIG. 1A shows a non-limiting example of a roofing membrane accessory, according to at least one embodiment disclosed herein, the accessory being wrapped around a wooden post and also adhered to a plywood substrate;

FIG. 1B provides a schematic of a roofing membrane accessory having an elastomeric layer, a butyl-based layer, and a protective layer.

FIG. 1C provides a schematic of a roofing membrane accessory having an elastomeric layer and a protective layer.

FIG. 1D provides a schematic of a roofing membrane accessory having an elastomeric layer interposed between two protective layers.

FIG. 1E provides a schematic of a roofing membrane accessory having an elastomeric layer, a butyl-based layer, and a protective layer interposed between two protective layers.

FIG. 2 provides a schematic illustrating a method for making the roofing accessory;

FIG. 3 shows a schematic view of a non-limiting processing equipment used in the production of the roofing accessory;

FIG. 4 is a stress versus strain curve of Examples 3, 7, and an EPDM control;

FIG. 5 is a stress versus strain curve of Examples 1, 2, 7, an EPDM control, and a white butyl control;

FIG. 6 is a cross-sectional photograph of Example 1 applied onto a white butyl layer;

FIG. 7 is a cross-sectional photograph of Example 7 applied onto a white butyl layer;

FIGS. 8A and 8B show visual results of the Heat Aging Bleed Resistance test of Example 7 applied over various substrates at 4 and 8 weeks at 80° C., respectively; and

FIGS. 9A and 9B show visual results of the UV Bleed Resistance test of Example 7 applied over various substrates at 4 and 8 weeks, respectively.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

Throughout this application, where publications are referenced, the disclosures of these publications in their entireties are hereby incorporated by reference into this application to more fully describe the state of the art to which this invention pertains.

### Abbreviations

“EPDM” means ethylene propylene diene monomer.

“PHR” means parts per 100 parts by weight of rubber.

“SUS” means Saybolt Universal Seconds.

The term “ethylidene norbornene” refers to one or both of compounds having formula 1 or

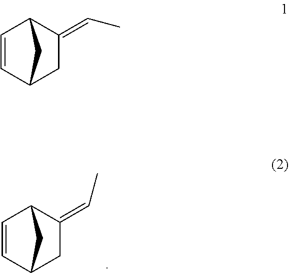

Therefore, the compositions described herein as having ethylidene norbornene can includes either compound or a combination of both.

The term “vinyl norbornene” refers to compounds having the following formula:

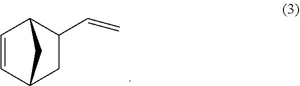

The term “dicyclopentadiene” refers to compounds having the following formula:

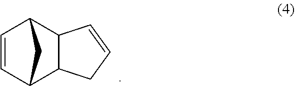

The term “norbornadiene” refers to compounds having the following formula:

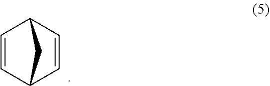

The term “parts per hundred rubber” means the mass proportions of the individual components in a recipe for an elastomer mixture.

The term “butyl-based layer” refers to a layer that includes isobutylene residues (i.e., isobutylene derived monomer units). In other words, a butyl-based layer is a layer formed by polymerizing isobutylene and in particular, polymerizing isobutylene with isoprene. In a refinement, the butyl-based layer is a rubber layer that includes monomer units derived from isobutylene.

The term “non-crosslinked” means that there is less than 20% gel content as measured per ASTM D2765. In a refinement, “non-crosslinked” means that there is less than 10% gel content as measured per ASTM D2765. In other refinements, “non-crosslinked” means that there is less than 10% gel content, 5% gel content, 3% gel content, 1% gel content, or 0.5% gel content as measured per ASTM D2765. In another refinement, “non-crosslinked” means that there is 0% gel content as measured per ASTM D2765.

It is an object of the present disclosure to provide a roofing membrane accessory solving one or more problems described above. In one or more embodiments, a roofing accessory is disclosed. The accessory may function as flashing or an impervious material configured to prevent ingress of water and other matter into a structure from a joint or as part of a weather resistant barrier system. The accessory may further serve as a ridge, hip, eave, fascia, gable, or drip edge.

The accessory may be configured as a sheet material. The accessory may be a membrane. The accessory may include at least one layer. The accessory may include more than one layer. Each layer may have the same or different chemical composition. At least one of the layers may have a different composition than at least one another layer or all of the remaining layers.

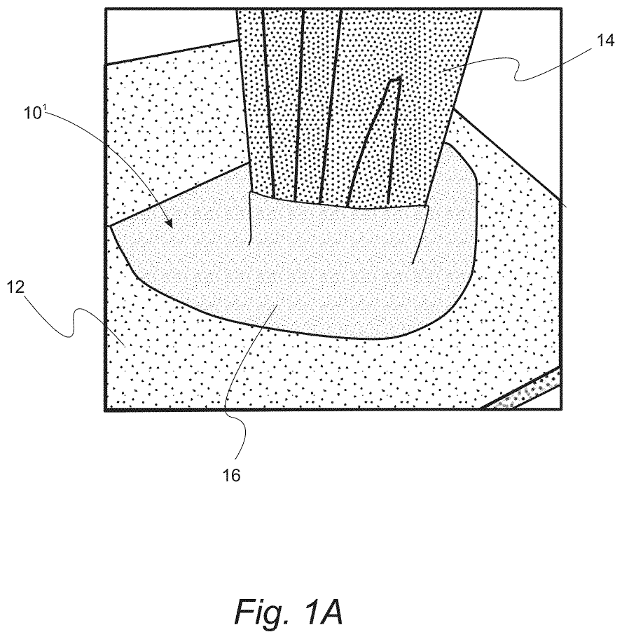

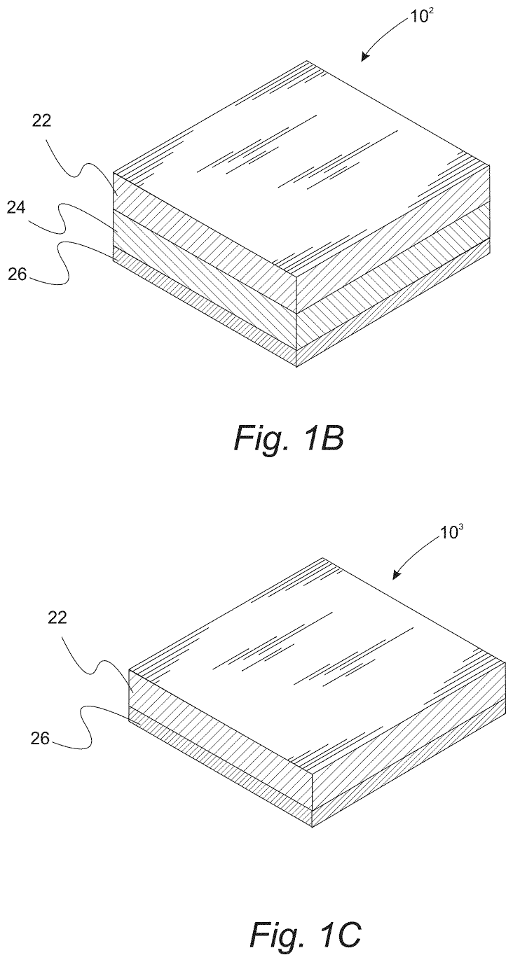

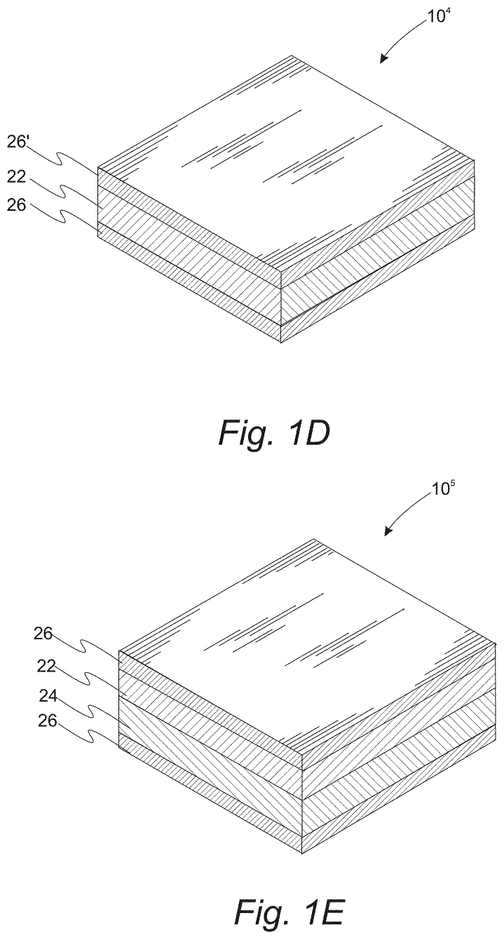

Referring to FIG. 1A, a non-limiting example of the herein-disclosed accessory is shown. FIG. 1A depicts the accessory 10¹ adhered to a substrate 12 such as plywood board and a structure 14 such as a wooden pillar. The accessory 10¹ is wrapped around three sides of the pillar, defining contours of the pillar. In FIG. 1, the accessory has a single layer 16 having the same composition as the elastomeric layer set forth below.

Referring to FIG. 1B, a non-limiting example of the accessory is provided. Accessory 10² can include elastomeric layer 22, a butyl-based layer 24 adjacent to the elastomeric layer 22, and a protective layer 26 configured as a liner. Typically, the protective layer arranged adjacent to the butyl-based layer such that the butyl-based layer is sandwiched between the elastomeric layer 22 and protective layer 26. Details of each layer are set forth below.

The elastomeric layer 22 may be configured to adhere to synthetic rubber material including silane-grafted polyolefin elastomer compositions, more specifically to silane-crosslinked polyolefin elastomer blends and/or to other layers and materials such as butyl tape. A specific example of a material the herein-disclosed accessory is compatible with, and adheres to, may be a silane-crosslinked polyolefin elastomer blend having one or more of the following components: a first polyolefin having a density less than 0.86 g/cm³, a second polyolefin having a percent crystallinity less than 40%, and a silane crosslinker. The blend may have a compression set of from about 5.0% to about 78.0% as measured according to ASTM D 395 (22 hours at 70° C.). The blend may have a density less than 0.9, 0.7, or 0.6 g/cm³. The first polyolefin may be an ethylene-octene copolymer from about 60 wt. % to about 97 wt. %. The second polyolefin may be a polypropylene homopolymer from about 10 wt. % to about 35 wt. % and/or a poly(ethylene-co-propylene). The silane crosslinker may be a vinyltrimethoxy silane from about 1 wt. % to about 4 wt. %. The condensation catalyst may be a sulfonic acid or alkyl sulfonic acid from about 1 wt. % to about 4 wt. %. A list of materials compatible with the disclosed roofing accessory is provided in U.S. Pat. No. 10,570,236 and U.S. Publication Nos. US 2018-0163031, 2018-0162978, 2018-0163024, which are incorporated by reference herein.

The elastomeric layer 22 may include one or more sublayers having the same or different chemical composition. The elastomeric layer may be the single and only layer in the accessory. The elastomeric layer, and thus the accessory, may be self-sealing, self-adhesive, or both.

Referring to FIG. 1B, roofing accessory 10² includes a butyl-based layer 24 located adjacent to the elastomeric layer 22. The butyl-based layer 24 may be connected, attached, laminated, adhered to, co-extruded, or otherwise provided immediately next to the elastomeric layer 22. The butyl-based layer 24 may be a butyl layer. The butyl layer may have smaller thickness than the elastomeric layer. The butyl layer may have a thickness equal to or about equal to the elastomeric layer. The butyl layer may be connected to the elastomeric layer and a protective layer. The connection may be facilitated chemically and/or mechanically.

Referring to FIG. 1B, roofing accessory 10² includes a protective layer 26. The protective layer 26 may be in contact with one of the first and/or butyl-based layer's surfaces. The protective layer 26 may include a release sheet. The release sheet may be adhered to the first and/or butyl-based layer's surface. The release sheet is arranged to prevent pre-installation adhesion to various surfaces, enable storage and transportation of the accessory. The protective layer may be a liner. The protective layer may be siliconized paper release sheet.

FIG. 1C depicts a variation not including butyl-based layer 24. In this variation, roofing accessory 10³ includes elastomeric layer 22 in direct contact with the protective layer 26.

FIG. 1D depicts another variation in which the protective layer may be applied to two opposing surfaces of the elastomeric layer. In this variation, roofing accessory 10⁴ includes protective layer 26 disposed over and optionally contacting a bottom face of elastomeric layer 22 and a protective layer 26′ disposed over and optionally contacting a top face of elastomeric layer 22.

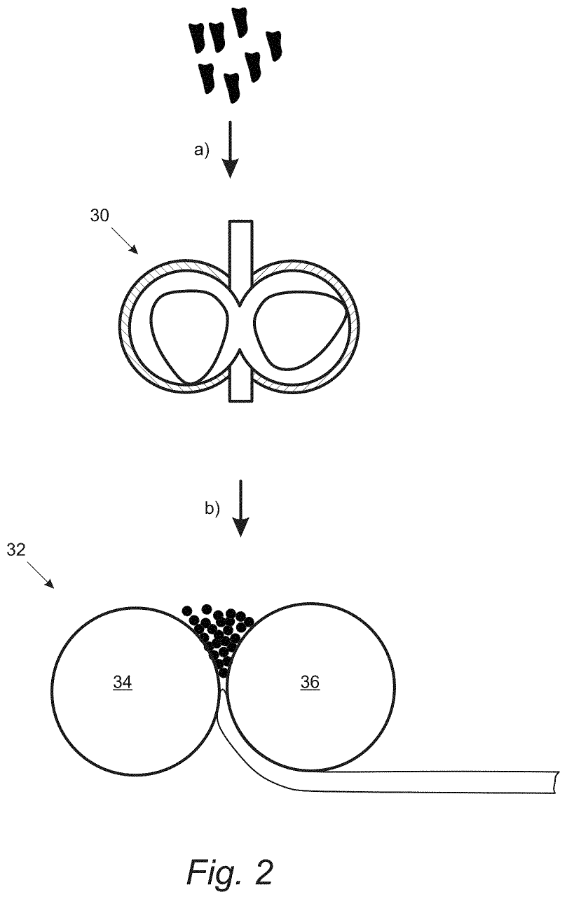

FIG. 1D depicts a variation in which the protective layer may be applied to both the elastomeric layer and the butyl-based layer, providing prevention of adhesion of the butyl layer as well as the elastomeric layer further defined below. In this variation, roofing accessory 10⁵ includes butyl-based layer 24 interposed between elastomeric layer 22 and protective layer 26 as described above for the design of FIG. 2. Protective layer 26 is disposed over and optionally contacting a top face of elastomeric layer 22.

Advantageously, single layer 16 and elastomeric layer 22 provides adhesion to at least one of synthetic rubber material, brick, reinforced glass, stone, rock, concrete, metal, ceramic, plastic such as vinyl, composite, wood, plywood, or a combination thereof, primed and unprimed. In a variation, single layer 16 and elastomeric layer 22 independently include a non-crosslinked elastomeric material having a composition including:

(A) 100 PHR of a base polymer including ethylene propylene diene monomer (EPDM) having ethylidene norbornene (ENB) content of about 0 to 9 wt. %,

(B) about 50 to 300 PHR of a calcium carbonate; and

(C) about 50 to 200 PHR of a dewaxed heavy paraffinic process oil(s).

In another variation, single layer 16 and elastomeric layer 22 independently include a non-crosslinked elastomeric material having a composition including:

(A) a base polymer;

(B) calcium carbonate; and

(C) oil(s);

and optionally:

(D) silane-grafted component(s);

(E) silicon gum(s);

(F) titanium dioxide;

(G) modifier(s) of physical properties;

(H) stabilizer(s);

(I) antioxidant(s); and

(J) other additives.

The non-crosslinked elastomeric material is free of a catalyst and/or curative. capable of initiating crosslinking or curing of any component, especially components (A) and/or (D). Because crosslinking connects polymer chains to each other permanently, a crosslinked structure typically becomes less flexible. Rigidity and loss of elasticity are undesirable with respect to the herein-disclosed roofing accessory. It is desirable that the accessory is not crosslinked so that the material is pliable and retains flexibility, which is needed for the accessory's application around irregular contours of roofing structures, as discussed above. It is desirable that the accessory remains in its uncured state at least until the accessory installation is complete. The accessory thus remains in a first, uncured non-crosslinked state, during and after the manufacturing process, during storage, during transportation, during installation, and/or at least for a time period after installation. The time period may be predetermined. The time period may be about, at least about, not less than about weeks, months, or years. The absence of a catalyst/curative slows down the curing process that occurs after installation of the accessory as part of a roofing application. After the time period, the accessory may transition into a second state when the non-crosslinked elastomeric material becomes partially crosslinked to a very minimal degree. The material's final level of crosslinking is about, at most about, no more than about 10 to 15%.

Non-limiting examples of component (A), the base polymer, may include one or more compounds. The one or more compounds may include elastomers having a saturated chain, unsaturated chain, or both. The chain may be of the polyethylene type. The base polymer may be compatible with polar substances. The component (A) may be non-crosslinked.

The base polymer may include ethylene propylene diene (EPDM) and thus include ethylene, propylene, and diene copolymer enabling crosslinking via vulcanization. EPDM of the component (A) may be characterized by Mooney viscosity ML (1+4) at 125° C. of about, at least about, at most about, not more than about 25 to 85, 40 to 70, or 48 to 52.

To prevent crosslinking and discourage pre-installation cure, as discussed above, the elastomeric compound may contain relatively low amount of diene units or no diene units. EPDM of the present disclosure may thus be characterized by the amount of diene units the EPDM includes, specifically by the ethylidene norbornene (ENB), vinyl norbornene (VNB), norbornadiene, 1,4 hexadiene and/or dicyclopentadiene (I)CPI)) content. ENB includes an ethylene group attached to norbornene and two sites of unsaturation. EPDM's level of unsaturation of the backbone may be defined by ENB content and/or VNB content and/or norbomadiene and/or 1,4 hexadiene content, and/or DCPD content or the sum of the content for each of these diene units. The ENB content and/or VNB content and/or norbomadiene and/or 1,4 hexadiene content, and/or DCPD content can each independently range from about 0 to 9, 2 to 8.7, or 4.5 to 6 wt. %. Alternatively, the sum of each of these diene monomers can range from about 0 to 9, 2 to 8.7, or 4.5 to 6 wt. %. The ENB content and/or VNB content and/or norbornadiene and/or 1,4 hexadiene content; and/or DCPD content may each independently be about, at least about, at most about, not more than about 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0. The ENB content and/or VNB content and/or norbornadiene and/or 1,4 hexadiene content, and/or DCPD content may be a range between any two numbers named above. In a refinement, the sum of ENB content and VNB content and norbornadiene and 1,4 hexadiene content and DCPD content may be a range between any two numbers named above. In particular, the sum of ethylidene norbornene (ENB) content, vinyl norbornene (VNB) content, norbornadiene content, and 1,4 hexadiene content and/or dicyclopentadiene (DCPD) content can range from about 0 to 9 wt. %. In a refinement, the sum of ethylidene norbornene (ENB) content, vinyl norbornene (VNB) content, norbornadiene content, and/or 1,4 hexadiene content and dicyclopentadiene (DCPD) content is from 4.5 to 6 wt. %. In a refinement, the sum of ethylidene norbornene (ENB) content, vinyl norbornene (VNB) content, norbornadiene content, and 1,4 hexadiene content and dicyclopentadiene (DCPD) is about 2 to 8.7 wt. %.

Alternatively, or in addition, to EPDM, the elastomeric compound may contain components free of diene units such as ethylene-propylene rubber (EPR or EPM) and/or other components which have no diene, are free of diene units, or lack diene units.

The component (A) may be further characterized by ethylene content, or the amount of the —CH₂ groups which can affect the component's hardness, elongation, compression set, and other properties. The lower the ethylene content, the lower the crystallinity of the base polymer. The base polymer's ethylene content may be about, at least about, at most about, not more than about 48 to 75, 50 to 70, or 58 to 62 wt. %. The base polymer's ethylene content may be about, at least about, at most about, not more than about 48, 50, 52, 54, 56, 58, 60, 62, 64, 66, 68, or 70 wt. %. The base polymer's ethylene content may be any range between any two numbers named above.

The component (A) may include a polyolefin elastomer. The component (A) may include an olefin block copolymer, alternating block copolymer, random block copolymer, polypropylene based olefin block copolymer, ethylene-based olefin block copolymer, random ethylene propylene block copolymer, or a combination thereof. The block copolymer may include ethylene or propylene monomers polymerized with aliphatic C₂-C₂₀ α-olefins such as ethylene, propylene, 1-butene, 4-methyl-1-pentene, 1-hexene, 1-octene, 1-decene, 1-dodecene, 1-tetradecene, 1-hexadecene, 1-octadecene and 1-eicosene.

The block copolymer may be characterized by the melt flow index (MFI) measured at 190° C. of about 0.5 to 15, 1 to 10, or 1.5 to 10 g/10 min, measured according to ASTM D1238. The block copolymer may have density of about 0.50 to 1.00, 0.70 to 0.90, or 0.87 to 0.88 g/cc, measured according to ASTM D792. The block copolymer may have compression set of about 15 to 25, 16 to 20, or 17 to 19% at temperature of 21° C. The block copolymer may have a melting point of about 100 to 130, 115 to 125, or 118 to 120° C. The block copolymer may have Shore A hardness of about 50 to 80, 55 to 75, or 60 to 65, measured according to ASTM D2240.

The amount of component (A) is 100 PHR or parts per hundred rubber. In some examples discussed below, component (A) is provided at more than 100 PHR which should be understood as a 100 parts rubber with the excess amount above one hundred being oil. For example, 200 PHR indicating 100 PHR oil within the component (A). Similarly, some examples provide for an amount of component (A) that is less than 100 PHR which indicates that the rubber is blended with another polymer as described herein.

Component (B) is calcium carbonate (CₐCO₃). Calcium carbonate serves as a filler that helps reduce the cost of the composition. Calcium carbonate also contributes to elasticity, and/or brightness of the non-crosslinked elastomeric material. Component (B) should have high brightness, pure tint, or both for white accessory applications. Dry brightness of the calcium carbonate may be about 93.5 to 96 (Hunter reflectance). Refractive index of the calcium carbonate may be about, at least about, at most about, not more than about 1.58 to 1.6. Calcium carbonate may have whiteness greater than or equal to about 89, 90, 91, 92, 93, 94, 95, or 96% measured on Elrepho spectrophotometer (457 nm). Calcium carbonate used as component (B) may have ultra-fine, fine, medium-fine, and/or granular particle size. Calcium carbonate may include a mix of different sizes named herein. Calcium carbonate may have median particle size of about, at least about, at most about, not more than about 1 to 22, 5 to 20, or 10 to 18 μm. Calcium carbonate may have median particle size of about, at least about, at most about, not more than about 1, 2, 3, 4, 5, 6, 7, 8, 9, 10, 11, 12, 13, 14, 15, 16, 1,7 18, 19, 20, 21, or 22 μm. Calcium carbonate may have median particle size of about, at least about, at most about, not more than about 1 to 4 μm. Calcium carbonate may include precipitated calcium carbonate.

The non-crosslinked elastomeric material may include about 50 to 300, 100 to 200, or 125 to 175 PHR of the component (B). The non-crosslinked elastomeric material may include about 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 PHR of the component (B). The amount of Component (B) may be a range between any two numbers disclosed above.

In at least one embodiment, component (B) may be optional, not required. In such an embodiment, a higher amount of components (A), (F) or another component named herein may be included in the non-crosslinked elastomeric material to replace component (B). In such embodiment, the non-crosslinked elastomeric material may include about 0 to 300, 100 to 200, or 125 to 175 PHR of the component (B). The non-crosslinked elastomeric material may include about 0, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 PHR of the component (B). The amount of Component (B) may be a range between any two numbers disclosed above. Absence of the component (B) may render the non-crosslinked elastomeric material less economical.

Component (C) includes one or more oils. The oil(s) may be petroleum-based. The oil(s) may include naphthenic oils, paraffinic oils, alkanes, cycloalkanes, or a combination thereof. The oil(s) may include hydrotreated, dewaxed heavy paraffinic process oil(s). The oil(s) may have excellent color stability. The oil(s) may have color value of 1 to 2, measured according to ASTM D6045. The oil(s) may be colorless. The oil(s) may be white oil(s). The oil(s) may be transparent. The oil(s) may have refractive index at 20° of about 1.47, measured according to ASTM D1218. The oil(s) may be characterized by a viscosity of 1 to 10,000 SUS at 100° F. per ASTM D2161 or more preferably 10 to 5,000 SUS or even more preferably 30 to 3,000 SUS.

The non-crosslinked elastomeric material may include about 50 to 200, 75 to 150, or 100 to 125 PHR of the component (C). The non-crosslinked elastomeric material may include about 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or 200 PHR of the component (C). The amount of Component (C) may be a range between any two numbers disclosed above.

In at least one embodiment, the non-crosslinked elastomeric material may include component (D), a silane grafted component. The silane-grafted component may be a silane grafted elastomer. The silane-grafted component may include one or more silane-grafted polyolefins. The silane-grafted polyolefin can be a polymer or copolymer of aliphatic C₂-C₂₀ α-olefins such as ethylene, propylene, 1-butene, 4-methyl-1-pentene, 1-hexene, 1-octene, 1-decene, 1-dodecene, 1-tetradecene, 1-hexadecene, 1-octadecene and 1-eicosene. The silane-grafted component may include one or more copolymers. The silane-grafted component may include ethylene-1-butene copolymer, ethylene propylene copolymer, ethylene/α-olefin copolymer, propylene/α-olefin copolymer, or a combination thereof.

The silane grafted component (D) is catalyst free to prevent crosslinking and to prevent formation of a silane-crosslinkable polyolefin elastomer.

To facilitate silane grafting, a silane mixture is combined with the one or more polyolefins. The silane mixture may include one or more silanes (e.g., silane cross linkers), oils, peroxides, antioxidants, and/or other components such as a grafting initiator. Example silanes may include vinyl trimethoxy silanes, vinyl triethoxy silanes, or any other alkoxy silanes. The component (D) is grafted prior to addition of component (D) to the non-crosslinked elastomeric material.

Non-limiting examples of the component (D) may include an ethylene-1-butene copolymer characterized by ML 1+4/121° C.: 20, MFR (190° C., 2.16 KG) 1.2 g/10 min, and density of 0.862 g/cc, Shore A hardness of 46 and/or an ethylene propylene copolymer characterized by MFR (230° C., 2.16 KG) 25 g/10 min, density of 0.868 g/cc, Shore A hardness of 84, and total crystallinity of about 16%.

The non-crosslinked elastomeric material may include about 0 to 50, 10 to 40, or 20 to 30 PHR of the component (D). The non-crosslinked elastomeric material may include about 0, 1, 2, 3, 4, 5, 6, 7, 8, 9, 10, 12, 14, 16, 18, 20, 22, 24, 26, 28, 30, 32, 34, 36, 38, 40, 42, 44, 46, 48, or 50 PHR of the component (D). The amount of Component (D) may be a range between any two numbers disclosed above.

In a non-limiting embodiment, the non-crosslinked elastomeric material includes one or more silicon gum(s) as component (E). The silicon gum(s) may be included to enhance elasticity, flexibility, and/or pliability of the non-crosslinked elastomeric material. The component (E) may include a high loading of about 70 wt. % ultrahigh molecular weight siloxane polymer, the remainder being fumed silica content of about 30 wt. %. The component (E) may be translucent. The component (E) may be pelletized.

The non-crosslinked elastomeric material may include about 0 to 1.5, 0.1 to 1, or 0.2 to 0.5 PHR of the component (E). The non-crosslinked elastomeric material may include about 0, 0.1, 0.2, 0.3, 0.4, 0.5, 0.6, 0.7, 0.8, 0.9, 1.0, 1.2, 1.3, 1.4, or 1.5 PHR of the component (E). The amount of Component (E) may be a range between any two numbers disclosed above.

The non-crosslinked elastomeric material may include component (F), titanium dioxide. Titanium dioxide may be added to increase brightness of the accessory, to impart a neutral tone in white, or both. Titanium dioxide may have high tinting strength, high hiding power, or both. Titanium dioxide may be coated with silica, alumina, or zirconia, or another compound.

The accessory may be white or whitish to color-match the roofing membrane material it is compatible with and is to be adhered to. Ideally, the color of the accessory has the same dominant wavelength, RGB, L*a*b, L*C*H, and/or HSL coordinates as the roofing material the accessory is to be installed with. In another refinement, the color of the accessory has a dominant wavelength that is within 1 percent, 2 percent, 5 percent or 10 percent of the dominant wavelength of the roofing material the accessory is to be installed with. In another refinement, the color of the accessory has RGB coordinates that are within 1 percent, 2 percent, 5 percent or 10 percent of the RGB coordinates of the roofing material the accessory is to be installed with. In another refinement, the color of the accessory has L*a*b coordinates that are within 1 percent, 2 percent, 5 percent or 10 percent of the L*a*b coordinates of the roofing material the accessory is to be installed with. In another refinement, the color of the accessory has L*C*H coordinates that are within 1 percent, 2 percent, 5 percent or 10 percent of the L*C*H coordinates of the roofing material the accessory is to be installed with. In another refinement, the color of the accessory has HSL coordinates that are within 1 percent, 2 percent, 5 percent or 10 percent of the of HSL coordinates the roofing material the accessory is to be installed with. “Dominant wavelength” refers to a way of describing polychromatic light mixtures in terms of monochromatic light that evokes an identical perception of hue. It is determined on the International Commission on Illumination (CIE)'s color coordinate space by a straight line between the color coordinates for the color of interest and the coordinates for the illuminate. The intersection at the perimeter of the coordinate space nearest the color of interest is the dominant wavelength. RGB coordinates relate to an RGB additive color model in which red, green, and blue light are added together in various ways to reproduce a broad array of colors. The accessory may have a color which may be defined as pure white, off white, cream, eggshell, ivory, or the like. For example, the accessory may have RGB coordinates of R, G, and B being any number between 245 and 255; RGB coordinates 255, 255, 255 being defined as pure white. Non-limiting example RGB coordinates may thus be in a range of 245, 245, 245 to 255, 255, 255. A wider range may include 230, 230, 230 to 255, 255, 255.

The component (F) may be also characterized by colorimetric values L*, brightness and b*, tone of the coating samples pigmented with the component (F), according to DIN 55983. The component (F) may have the following L* values: about 96.5 to 98.0, 97.0 to 97.9, or 97.2 to 97.4. The component (F) may have the following b* values: about 1.5 to 2.5, 1.8 to 2.4, or 2.0 to 2.1.

The non-crosslinked elastomeric material may include about 0 to 30, 6 to 20, or 8 to 15 PHR of the component (F). The non-crosslinked elastomeric material may include about 4 to 5 PHR of the component (F). The non-crosslinked elastomeric material may include about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 PHR of the component (F). The amount of Component (F) may be a range between any two numbers disclosed above.

The non-crosslinked elastomeric material may include component (G), modifier of physical properties. The modifier may include a component increasing strength, polarity, flexibility, adjusting surface tension, flow and leveling properties, increasing wet edge and/or antifreeze properties, improving pigment stability, controlling foaming, the like, or a combination thereof.

Non-limiting examples of the component (G) may include HDPE. A non-limiting example of HDPE may be characterized by specific gravity (SG) of about 0.955 g/cc, melt index 0.3 g/10 min, measured according to ASTM D1238.

Another non-limiting example of component (G) may include a random copolymer of ethylene and butyl acrylate characterized by melt index at 190° C. of about 6.5 to 8 g/10 min, measured according to ASTM D1238, flexural modulus 40 MPa, measured according to ASTM D790, and butyl acrylate content of about 16 to 19 wt. %.

The non-crosslinked elastomeric material may include about 0 to 35, 10 to 30, or 15 to 25 PHR of the component (G). The non-crosslinked elastomeric material may include about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 PHR of the component (G). The amount of Component (G) may be a range between any two numbers disclosed above.

The non-crosslinked elastomeric material may include component (H), one or more stabilizers. The stabilizer(s) may include Ultraviolet Light Absorbers (UVA), Hindered-Amine Light Stabilizers (HALS), or both. The stabilizers may be used to enhance color retention, improve durability, maintain surface properties such as gloss, prevent cracking, extend lifetime of the accessory, and the like. Non-limiting examples of stabilizers may include high molecular weight hydroxylamine, phosphite processing stabilizers, or a phenolic stabilizers.

The non-crosslinked elastomeric material may include about 0 to 3.0, 0.1 to 2.5, or 0.5 to 1.5 PHR of the component (H). The non-crosslinked elastomeric material may include about 0, 0.1, 0.2, 0.3, 0.4, 0.5, 0.6, 0.7, 0.8, 0.9, 1.0, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 PHR of the component (H). The amount of Component (H) may be a range between any two numbers disclosed above.

The non-crosslinked elastomeric material may include component (I), one or more antioxidants. The antioxidant(s) may be added to protect the accessory against oxygen. A non-limiting example of an antioxidant may be a hindered phenolic antioxidant.

The non-crosslinked elastomeric material may include about 0 to 2.0, 0.1 to 1.5, or 0.5 to 1.0 PHR of the component (I). The non-crosslinked elastomeric material may include about 0, 0.1, 0.2, 0.3, 0.4, 0.5, 0.6, 0.7, 0.8, 0.9, 1.0, 1.2, 1.3, 1.4, 1.5, 1.6, 1.7, 1.8, 1.9, or 2.0 PHR of the component (I). The amount of Component (I) may be a range between any two numbers disclosed above.

The non-crosslinked elastomeric material may include one or more additives (J). The component (J) may include one or more fillers, pigments, texturizers, biocides, fungicides, insecticides, algaecides, the like, or a combination thereof. A non-limiting example of component (J) may include zinc oxide, carbon black, talc, or a combination thereof.

Pigments may enable the non-crosslinked elastomeric material and thus the accessory to color-match the base roofing material. Any color may be achieved, providing color flexibility to the accessory. Non-limiting example pigments may include one or more types of clay, silica, or talc. Additional inorganic pigment examples may include pigments based on Al, Ba, Cu, Mn, Co, Fe, Cd, Cr, Sb, Zn, Ti, the like, or their combination. The pigments may be organic.

The non-crosslinked elastomeric material may include about 0 to 10.0, 0.1 to 5.0, or 0.5 to 1.0 PHR of the component (J). The non-crosslinked elastomeric material may include about 0, 0.1, 0.2, 0.3, 0.4, 0.5, 0.6, 0.7, 0.8, 0.9, 1.0, 1.2, 1.3, 1.4, 1.5, 1.6, 1.7, 1.8, 1.9, 2.0, 2.5, 3.0, 3.5, 4.0, 4.5, 5.0, 5.5, 6.0, 6.5, 7.0, 7.5, 8.0, 8.5, 9.0, 9.5, or 10.0 PHR of the component (J). The amount of Component (J) may be a range between any two numbers disclosed above.

The components (A) through (J) may be in a liquid, powder, platform, strip, slab, or pelletized form, or a mixture thereof.

The non-crosslinked elastomeric material including the components (A) through (C) and optionally one or more components (D) through (J) may have the following properties listed herein. The values are also valid for an embodiment in which the component (B) is optional. The values are given for green, uncured state of the non-crosslinked elastomeric material.

The non-crosslinked elastomeric material may have Approximate Specific Gravity of about 1.0 to 1.7, 1.1 to 1.5, or 1.2 to 1.4 g/cc. The non-crosslinked elastomeric material may have Approximate Specific Gravity of about 1.0, 1.1, 1.2, 1.3, 1.4, 1.5, 1.6, or 1.7 g/cc. The Approximate Specific Gravity of the non-crosslinked elastomeric material may be a range including any two numbers described above. The values are according to ASTM D297 testing method.

The non-crosslinked elastomeric material may have Mooney viscosity (1+4 at 100° C.) of about 10 to 60, 15 to 55, or 20 to 40. The non-crosslinked elastomeric material may have Mooney viscosity of about 10, 12, 15, 18, 20, 22, 25, 28, 30, 32, 35, 38, 40, 42, 45, 48, 50, 52, 55, 58, or 60. The non-crosslinked elastomeric material may have Mooney viscosity of about 18 (1+4 at 100° C.). The Mooney viscosity of the non-crosslinked elastomeric material may be a range including any two numbers described above. The values are according to ASTM D1646 testing method.

The non-crosslinked elastomeric material may have Hardness of about 35 to 80, 45 to 65, or 50 to 60 Asker C/Durometer E. The non-crosslinked elastomeric material may have Hardness of about 35, 40, 45, 50, 55, 60, 65, 70, 75, or 80 Asker C/Durometer E. The Hardness of the non-crosslinked elastomeric material may be a range including any two numbers described above. The values are according to ASTM D2240 testing method.

The non-crosslinked elastomeric material may have Tensile Strength of about 0.14 to 0.80, 0.18 to 0.50, or 0.20 to 0.40 MPa. In a refinement the Tensile Strength may be about 0.14 to 6.0, 1.0 to 5.5, or 3.0 to 5.0 The non-crosslinked elastomeric material may have Tensile Strength of about 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 1.0, 1.5, 2.0, 2.5, 3.0, 3.5, 4.0, 4.5, 5.0, 5.5 or 6.0 MPa. The Tensile Strength of the non-crosslinked elastomeric material may be a range including any two numbers described above. The values are according to ASTM D412 A testing method.

The non-crosslinked elastomeric material may have elongation at break of about 20 to 2400%, 400 to 2200%, 200 to 1200%, or 400 to 800%. In a refinement, Elongation at break may be about 1800 to 2500%, 1900 to 2400%, 2000 to 2300%. The non-crosslinked elastomeric material may have Elongation at break of about 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 300%, 310%, 320%, 330%, 340%, 350%, 360%, 370%, 380%, 390%, 400%, 410%, 420%, 430%, 440%, 450%, 460%, 470%, 480%, 490%, 500%, 510%, 520%, 530%, 540%, 550%, 560%, 570%, 580%, 590%, 600%, 610%, 620%, 630%, 640%, 650%, 660%, 670%, 680%, 690%, 700%, 710%, 720%, 730%, 740%, 750%, 760%, 770%, 780%, 790%, 800%, 810%, 820%, 830%, 840%, 850%, 860%, 870%, 880%, 890%, 900%, 910%, 920%, 930%, 940%, 950%, 960%, 970%, 980%, 990%, 1000%, 1010%, 1020%, 1030%, 1040%, 1050%, 1060%, 1070%, 1080%, 1090%, 1100%, 1110%, 1120%, 1130%, 1140%, 1150%, 1160%, 1180%, 1190%, 1200%, 1210%, 1220%, 1230%, 1240%, 1250%, 1260%, 1270%, 1280%, 1290%, 1300%, 1310%, 1320%, 1330%, 1340%, 1350%, 1360%, 1370%, 1380%, 1390%, 1400%, 1410%, 1420%, 1430%, 1440%, 1450%, 1460%, 1470%, 1480%, 1490%, 1500%, 1510%, 1520%, 1530%, 1540%, 1550%, 1560%, 1570%, 1580%, 1590%, 1600%, 1610%, 1620%, 1630%, 1640%, 1650%, 1660%, 1670%, 1680%, 1690%, 1700%, 1710%, 1720%, 1730%, 1740%, 1750%, 1760%, 1770%, 1780%, 1790%, 1800%, 1810%, 1820%, 1830%, 1840%, 1850%, 1860%, 1870%, 1880%, 1890%, 1900%, 1910%, 1920%, 1930%, 1940%, 1950%, 1960%, 1970%, 1980%, 1990%, 2000%, 2010%, 2020%, 2030%, 2040%, 2050%, 2060%, 2070%, 2080%, 2090%, 2100%, 2110%, 2120%, 2130%, 2140%, 2150%, 2160%, 2170%, 2180%, 2190%, 2200%, 2210%, 2220%, 2230%, 2240%, 2250%, 2260%, 2270%, 2280%, 2290%, 2300%, 2310%, 2320%, 2340%, 2350%, 2360%, 2370%, 2380%, 230%, 2400%, 2410%, 2420%, 2430%, 2440%, 2450%, 2460%, 2470%, 2480%, 2490%, and/or 2500%. The elongation of the non-crosslinked elastomeric material may be a range (e.g., between or to/from) including any two numbers described above. The values are according to ASTM D412 A testing method.

The non-crosslinked elastomeric material may have maximum elongation of about 200% to 1800%, 20% to 2400%, 400% to 2200%, 400% to 1400%, or 600% to 1200%. In a refinement, maximum elongation may be about 1800% to 2500%, 1900% to 2400%, 2000% to 2300%. The non-crosslinked elastomeric material may have Maximum Elongation of about 200%, 210%, 220%, 230%, 240%, 250%, 260%, 270%, 280%, 290%, 300%, 310%, 320%, 330%, 340%, 350%, 360%, 370%, 380%, 390%, 400%, 410%, 420%, 430%, 440%, 450%, 460%, 470%, 480%, 490%, 500%, 510%, 520%, 530%, 540%, 550%, 560%, 570%, 580%, 590%, 600%, 610%, 620%, 630%, 640%, 650%, 660%, 670%, 680%, 690%, 700%, 710%, 720%, 730%, 740%, 750%, 760%, 770%, 780%, 790%, 800%, 810%, 820%, 830%, 840%, 850%, 860%, 870%, 880%, 890%, 900%, 910%, 920%, 930%, 940%, 950%, 960%, 970%, 980%, 990%, 1000%, 1010%, 1020%, 1030%, 1040%, 1050%, 1060%, 1070%, 1080%, 1090%, 1100%, 1110%, 1120%, 1130%, 1140%, 1150%, 1160%, 1180%, 1190%, 1200%, 1210%, 1220%, 1230%, 1240%, 1250%, 1260%, 1270%, 1280%, 1290%, 1300%, 1310%, 1320%, 1330%, 1340%, 1350%, 1360%, 1370%, 1380%, 1390%, 1400%, 1410%, 1420%, 1430%, 1440%, 1450%, 1460%, 1470%, 1480%, 1490%, 1500%, 1510%, 1520%, 1530%, 1540%, 1550%, 1560%, 1570%, 1580%, 1590%, 1600%, 1610%, 1620%, 1630%, 1640%, 1650%, 1660%, 1670%, 1680%, 1690%, 1700%, 1710%, 1720%, 1730%, 1740%, 1750%, 1760%, 1770%, 1780%, 1790%, 1800%, 1810%, 1820%, 1830%, 1840%, 1850%, 1860%, 1870%, 1880%, 1890%, 1900%, 1910%, 1920%, 1930%, 1940%, 1950%, 1960%, 1970%, 1980%, 1990%, 2000%, 2010%, 2020%, 2030%, 2040%, 2050%, 2060%, 2070%, 2080%, 2090%, 2100%, 2110%, 2120%, 2130%, 2140%, 2150%, 2160%, 2170%, 2180%, 2190%, 2200%, 2210%, 2220%, 2230%, 2240%, 2250%, 2260%, 2270%, 2280%, 2290%, 2300%, 2310%, 2320%, 2340%, 2350%, 2360%, 2370%, 2380%, 230%, 2400%, 2410%, 2420%, 2430%, 2440%, 2450%, 2460%, 2470%, 2480%, 2490%, and/or 2500%. The Elongation of the non-crosslinked elastomeric material may be a range (e.g., between or from/to) including any two numbers described above. The values are according to ASTM D412 A testing method.

The elongation at break and maximum elongation values relate to both fresh non-crosslinked elastomeric material as well as the non-crosslinked elastomeric material after storage stability testing, specifically heat aging in an air circulating oven at 70° C. for 46 hours.

The non-crosslinked elastomeric material may have relatively low modulus enabling pliability of the material, as discussed above. The material may have Young's Modulus (15′/50° C.) [MPa at 100%] of about 0.01 to 0.25, 0.05 to 0.20, or 0.1 to 0.18. The non-crosslinked elastomeric material may have young's Modulus (15′/50° C.) [MPa at 100%] of about 0.01, 0.02, 0.03, 0.04, 0.05, 0.06, 0.07, 0.08, 0.09, 0.1, 0.11, 0.12, 0.13, 0.14, 0.15, 016, 0.17, 0.18, 0.19, 0.20, 0.21, 0.22, 0.23, 0.24, or 0.25. The Young's Modulus (15′/50° C.) [MPa at 100%] of the non-crosslinked elastomeric material may be a range including any two numbers described above. The values are according to ASTM D412 A testing method.

The non-crosslinked elastomeric material may have Peak Load of about 1 to 10, 2 to 8, or 3 to 6 N. The non-crosslinked elastomeric material may have Peak load of about 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10.0. The Peak Load of the non-crosslinked elastomeric material may be a range including any two numbers described above. The values are according to ASTM D412 testing method.

Besides good compatibility with the synthetic rubber materials including silane-grafted polyolefin elastomer compositions disclosed above, the non-crosslinked elastomeric material has good chemical compatibility with commercially available butyl tapes, with and without primer. The non-crosslinked elastomeric material also has good chemical compatibility with commercially available thermoplastic polyolefin (TPO) membranes. The non-crosslinked elastomeric material also has good chemical compatibility with commercially available PVC. The synthetic rubber materials, butyl tape, the TPO membrane, the PVC may be white in color, providing a visually satisfactory color match with the herein disclosed accessory. Alternatively, the accessory may include one or more pigments to have a predetermined color to color match the synthetic rubber materials, butyl tape, TPO membrane, or PVC.

A method of producing the accessory is likewise disclosed herein. In step a), components (A) through (C), and optionally one or more components (D) through (J) may be mixed together to form the disclosed non-crosslinked elastomeric material. The mixing may be conducted in a tangential internal mixer 30 traditionally used to process rubber compounds such as a Banbury mixer, as FIG. 2A shows. As is illustrated in FIG. 2A, the non-crosslinked elastomeric material has good processability such that the material does not adhere to the surfaces of the processing equipment such as the Banbury rotors, as depicted in FIG. 2A. In step b), once the components are mixed and incorporated, the non-crosslinked elastomeric material may be processed on a two-roll mill 32, shown in FIG. 2B, between a set of rollers 34 and 36 to form a sheets for accessories 10¹, 10², 10³, 10⁴, and 10⁵. Alternatively, the sheet forming may be provided by calendaring.

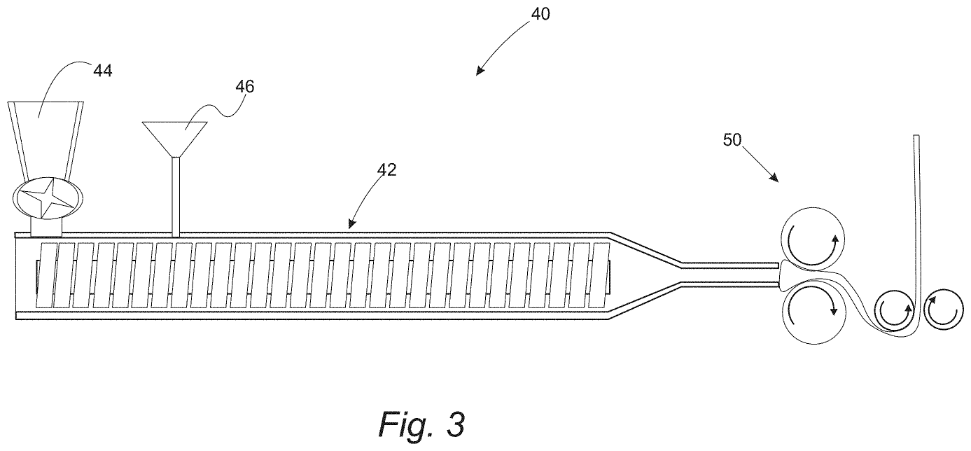

Alternatively, a twin-screw extruder or a single screw extruder or a compounding system may be utilized. FIG. 3 shows a schematic depiction of a non-limiting example processing equipment configured to produce the disclosed accessory. As FIG. 3 shows, extruder 40 includes mixing chamber, container, or barrel 42. The individual components may be fed via hoppers 44 into mixing chamber, container, or barrel 42. The component (C), one or more oil(s) may be supplied via a separate feeder 46 to the chamber, container, or barrel 42. The inside of the chamber, container, or barrel 42 includes a set of screws (not depicted) processing the components and forming the non-crosslinked elastomeric material. The mixed material proceeds to a calender 50 having two or more rollers. The number of rollers may be 2, 3, 4, or a different number. The calendaring process forms the mixed material into a tape or a sheet.

The formed tape or sheet represents the elastomeric layer described above. The butyl-based and protective layers may be optionally added onto one or two opposing surfaces of the sheet by various techniques such as laminating (FIG. 2B), extrusion (FIG. 3), the like, or a combination thereof. For example, the addition of the layers may be provided by laminating while sheeting if three or more rollers are used. The process may be conducted at ambient temperature of about 18-22° C., but also elevated temperatures higher than 22° C. or lower temperatures than 18° C.

The following examples illustrate the various embodiments of the present invention. Those skilled in the art will recognize many variations that are within the spirit of the present invention and scope of the claims.

### EXAMPLES 1-8

A single-layer in Examples 1-8 were prepared as described above. In addition, Example 6 included a silane-grafted component, grafting of which was completed before the individual components were inserted into the Banbury mixer. The mixed material was formed into a sheet on a roll mill, as described above.

Each Example 1-8 was produced in several samples (usually three), samples generally having different PHR of individual components, which is reflected in Table 1 below, where PHR is given in ranges for each example except 7 which is provided in wt. %.

TABLE 1
Composition and PHR of individual components of Examples 1-8, the
unit for each component for Examples 1-6 and 8 is PHR (parts per hundred rubber) and for
Example 7 in wt. %.

| Example no. | 1 | 2 | 3 | 4 | 5 | 6 | 6A | 7 | 8 |
|---|---|---|---|---|---|---|---|---|---|
| Component | [PHR] | [PHR] | [PHR] | [PHR] | [PHR] | [PHR] | [PHR] | [wt. %] | [PHR] |
| EPDM (ML | 100 | 100 | — | — | — | — | — | — | 100 |
| 1 + 4/125C: 70, | | | | | | | | | |
| ENB: 4.9%, | | | | | | | | | |
| Ethylene: 50%) | | | | | | | | | |
| EPDM (ML | — | — | 200 | — | — | 120- | 110- | — | — |
| 1 + 4/125C: 48- | | | | | | 180 | 180 | | |
| 52, ENB: 4.5- | | | | | | | | | |
| 8.7%, | | | | | | | | | |
| Ethylene: 58- | | | | | | | | | |
| 62%, PHR | | | | | | | | | |
| oil: 100) | | | | | | | | | |
| EPDM (ML | — | — | — | 40-60 | 40-60 | — | — | — | — |
| 1 + 4/125C: 70, | | | | | | | | | |
| ENB: 4.9%, | | | | | | | | | |
| Ethylene: 70%) | | | | | | | | | |
| Ethylene-1- | — | — | — | — | — | 9-34 | 5-35 | 35-45 | — |
| butene | | | | | | | | | |
| copolymer | | | | | | | | | |
| (ML | | | | | | | | | |
| 1 + 4/121C: 20, | | | | | | | | | |
| MFR | | | | | | | | | |
| (190C, 2.16K | | | | | | | | | |
| G): 1.2, | | | | | | | | | |
| Density: 0.862 | | | | | | | | | |
| g/cc, Shore | | | | | | | | | |
| A: 46) | | | | | | | | | |
| Ethylene | — | — | — | — | — | 6-1 | 1-10 | 5-10 | — |
| propylene | | | | | | | | | |
| copolymer | | | | | | | | | |
| (MFR | | | | | | | | | |
| (230C, 2.16K | | | | | | | | | |
| G): 25, | | | | | | | | | |
| Density: 0.868 | | | | | | | | | |
| g/cc, Shore | | | | | | | | | |
| A: 84, Total | | | | | | | | | |
| crystallinity: | | | | | | | | | |
| 16%) | | | | | | | | | |
| Olefin block | — | — | — | 40-60 | 40-60 | — | — | — | — |
| copolymer | | | | | | | | | |
| (Melt index | | | | | | | | | |
| (190C, 2.16K | | | | | | | | | |
| G): 0.5, | | | | | | | | | |
| Density: 0.877 | | | | | | | | | |
| g/cc, Shore | | | | | | | | | |
| A: 77, Melt | | | | | | | | | |
| Temp | | | | | | | | | |
| (DSC): 122° C.) | | | | | | | | | |
| Talc additive | 40-60 | 40-60 | — | — | — | — | — | — | 40-60 |
| Calcium | 165- | 165- | 240- | 90-110 | 90-110 | 140- | 120- | — | 190- |
| carbonate, | 185 | 185 | 260 | | | 160 | 170 | | 210 |
| small particle | | | | | | | | | |
| size | | | | | | | | | |
| Titanium | — | — | — | 10-30 | — | 2-8 | 2-15 | 2-8 | — |
| dioxide | | | | | | | | | |
| Carbon black | — | — | — | — | 10-30 | — | — | — | — |
| HDPE | — | — | — | 15-35 | 15-35 | — | — | — | — |
| (SG: 0.955 | | | | | | | | | |
| g/cc, melt | | | | | | | | | |
| index(ASTM | | | | | | | | | |
| D1238): 0.3 g/ | | | | | | | | | |
| 10 min) | | | | | | | | | |
| Zinc oxide | 0-5 | 0-5 | — | — | — | — | — | — | 0-5 |
| Dewaxed | 75 | 65 | 90-110 | 150- | 150- | 80-100 | 25-90 | 30-50 | 69-89 |
| white | | | | 170 | 170 | | | | |
| paraffinic oil | | | | | | | | | |
| Random | — | — | — | — | — | 1-9 | 1-9 | 1-9 | — |
| copolymer of | | | | | | | | | |
| Ethylene and | | | | | | | | | |
| Butyl | | | | | | | | | |
| Acrylate | | | | | | | | | |
| Pelletized | — | — | — | — | — | 0.2-1.0 | 0.2-1.0 | 0.2-1.0 | — |
| silicone gum | | | | | | | | | |
| Antioxidant + | 0.1-2.0 | 0.1-2.0 | — | 0.1-2.0 | 0.1-2.0 | 1.0-8.0 | 1.0-8.0 | 0.1-1.0 | 0.1-2.0 |
| stabilizer | | | | | | | | | |
| mixture | | | | | | | | | |
| Light | 0.1-2.3 | 0.1-2.3 | — | 0.1-1.0 | 0.1-1.0 | — | — | 0.8-2.0 | 0.1-2.3 |
| stabilizer | | | | | | | | | |
| including | | | | | | | | | |
| hindered | | | | | | | | | |
| amines | | | | | | | | | |
| Silane | — | — | — | — | — | 0.6-1.0 | 0.2-1.0 | 0-1 | — |
| composition | | | | | | | | | |
| Total PHR | 380.2- | 370.2- | 530- | 365.2- | 365.2- | 384.8- | 265.4- | — | 399.2- |
| | 429.3 | 419.3 | 570 | 448.0 | 448.0 | 477.0 | 519.0 | | 468.3 |
| Total wt. % | — | — | — | — | — | — | | 100 | — |

Examples 1 and 3-8 were applied onto an industry standard butyl roofing adhesive as a backing. Various properties of the butyl-backed Examples 1 and 3-8 were collected and are provided in Table 2. All Examples were measured in their green, uncured state.

TABLE 2
Physical and mechanical properties of Examples 1 and 3-8

| Example no. | 1 | 3 | 4 | 5 | 6 | 7 | 8 |
|---|---|---|---|---|---|---|---|
| Measured | | | | | | | |
| Property [unit]/ | | | | | | | |
| Testing Method | | | | | | | |
| Approximate | 1.419- | 1.236- | 1.034-1.163 | 1.022-1.147 | 1.100-1.190 | 0.88-0.92 | 1.419- |
| Specific Gravity | 1.483 | 1.259 | | | | | 1.550 |
| [g/cc] | | | | | | | |
| ASTM D297 | | | | | | | |
| Mooney viscosity | 20-50 | 15-40 | — | — | — | — | 20-55 |
| [1 + 4 at 100° C.] | | | | | | | |
| ASTM D1646 | | | | | | | |
| Hardness [Asker | — | 45-65 | — | — | — | — | — |
| C/Durometer E] | | | | | | | |
| ASTM D2240 | | | | | | | |
| Tensile strength | — | — | — | — | 0.36 | 0.47 | — |
| [MPa] (with | | | | | | | |
| Butyl) | | | | | | | |
| ASTM D412 A | | | | | | | |
| Elongation [%] | — | — | — | — | 800+ | 800+ | — |
| ASTM D412 A | | | | | | | |
| Young's | 0.04- | — | — | — | — | 0.07 | 0.04- |
| Modulus | 0.20 | | | | | | 0.20 |
| (15'/50° C.) [MPa | | | | | | | |
| at 100%] | | | | | | | |
| ASTM D412 A | | | | | | | |

The test conditions for Examples 1, 2, 3, 6, and 7 are described below. All Examples were tested in their green, uncured state. Examples 1 and 3-8 were backed with an industry standard butyl roofing adhesive.

(a) Examples 3 and 7 were evaluated in a stress test according to ASTM D412. Die A and a tensile tester with extensometer were used, test speed was 500 mm/min. Specifically, the test was conducted on:
a single layer Example 3 with no butyl layer, no aging;
an elastomeric layer of Example 3 attached to a butyl layer, no aging;
a single layer Example 7 with no butyl layer, no aging;
an elastomeric layer of Example 7 with a butyl layer after 6-month aging;
a single layer Example 7 with no butyl layer after 6-month aging; and
an EPDM control, a commercially available EPDM membrane material after 6-month aging.

The 6-month aging of Example 7 and the EPDM control was conducted as a storage stability heat testing in an air circulating oven at 70° C. for 46 hours.

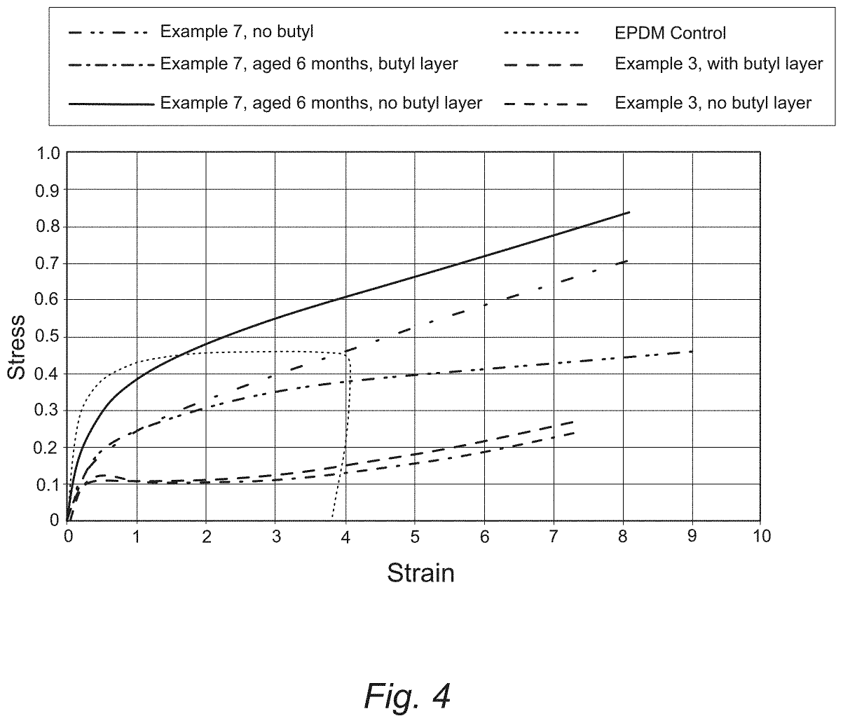

The resulting stress/strain data is captured in the graph of FIG. 4. Stress is designated in MPa. Strain is a dimensionless unit. As can be observed from FIG. 4, Example 3 exhibited a smooth elongation curve and much lower tensile strength than Example 7. Example 7 exhibited increased tensile strength due to the 6-month aging.

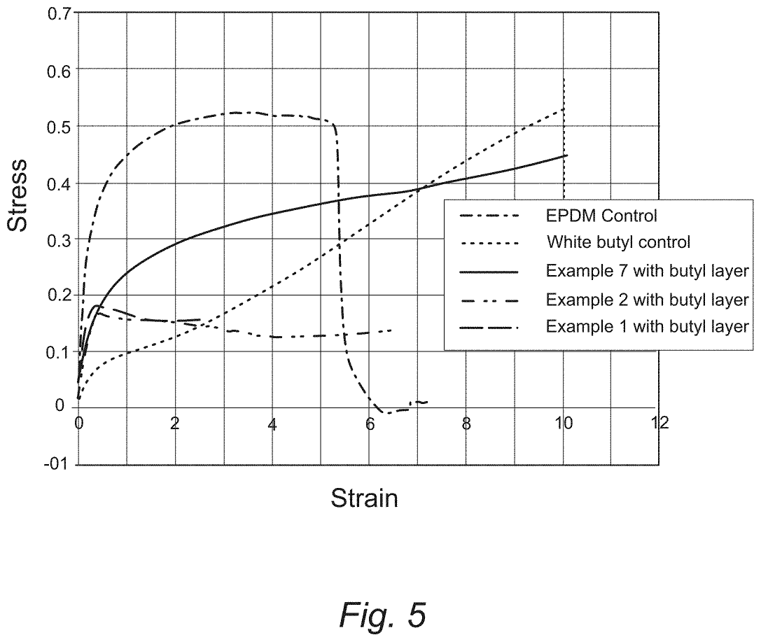

(b) Examples 1, 2, and 7, each attached to an industry standard white butyl roofing layer as a backing, were tested as described in (a) above. The commercially available EPDM control and a commercially available white butyl control were also tested. The resulting stress/strain data is captured in the graph of FIG. 5 and Table 3 below.

TABLE 3
Tensile test values for Examples 1, 2, 7, EPDM control, and
white butyl control

| Measured | | | | | |
|---|---|---|---|---|---|
| Property [unit]/ | Example | | | | |
| Testing | | | | EPDM | Butyl |
| Method | 1 | 2 | 7 | control | control |
| Area [mm²] | 33.02 | 16.77 | 16.77 | 14.835 | 19.435 |
| Peak Load [N] | 6.04 | 2.85 | 7.86 | 7.77 | 11.31 |
| ASTM D412 | | | | | |
| Tensile | 0.18 | 0.17 | 0.47 | 0.52 | 0.58 |
| Strength | | | | | |
| [MPa] | | | | | |
| ASTM D412 A | | | | | |
| Elongation | 20.17 | 38.45 | 1004.9 | 39.04 | 1005.3 |
| [%] | | | | | |
| ASTM D412 A | | | | | |
| Position at | 126.54 | 232.04 | 486.84 | 252.26 | 673.68 |
| Break [mm] | | | | | |
| ASTM D412 | | | | | |
| Max. | 253.22 | 652.14 | 1005 | 720.45 | 1005.3 |
| Elongation | | | | | |
| [%] | | | | | |
| ASTM D412 A | | | | | |

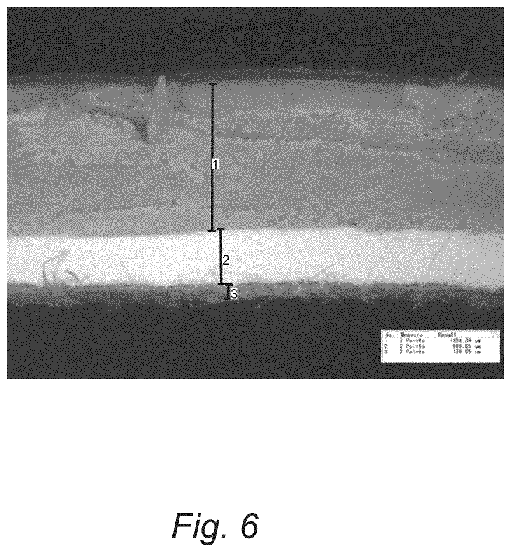

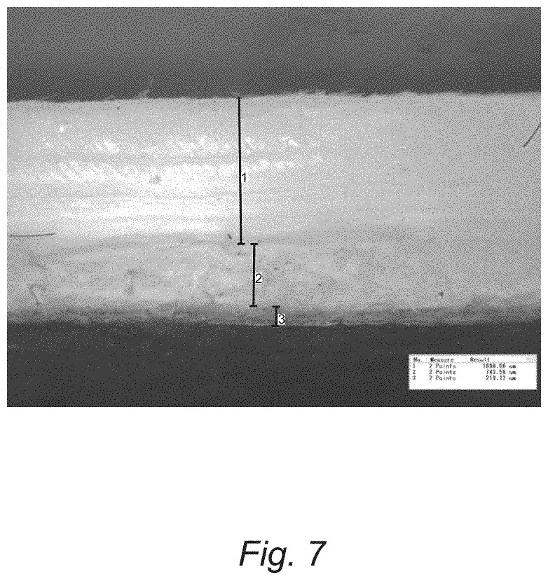

Examples 1 and 7 applied to a white butyl layer are shown in cross-section in FIGS. 6 and 7, respectively.

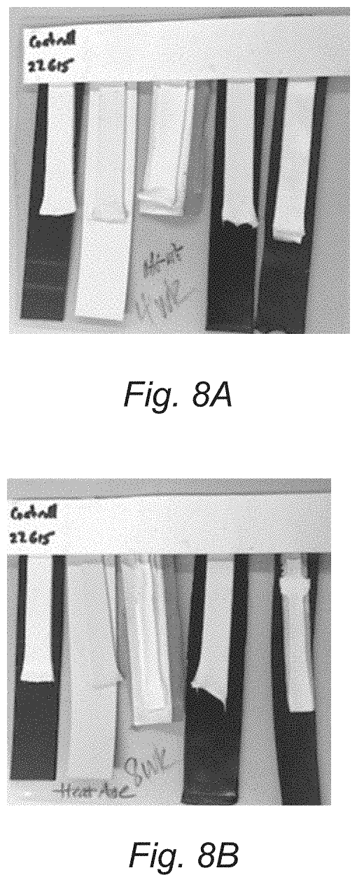

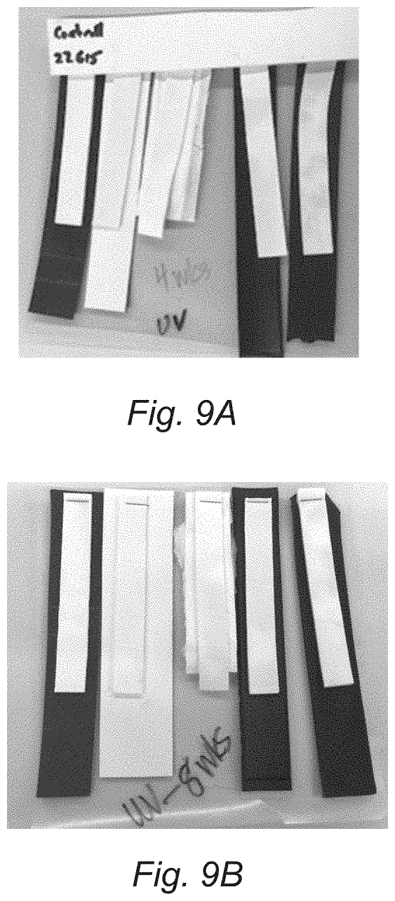

(c) Example 7 was further assessed for compatibility with various substrates, as can be observed from Table 4. FIGS. 8A and 8B illustrate test results for Heat Aging Bleed Resistance test of Example 7 applied over various substrates named in Table 4 at 4 and 8 weeks, respectively. FIGS. 9A and 9B illustrate test results for UV Exposure Bleed Resistance test of Example 7 applied over various substrates named in Table 4 at 4 and 8 weeks, respectively.

TABLE 4
Example 7 testing procedures and results

| Type of | | | |
|---|---|---|---|
| Assessment | Notes | Testing Method | Results |
| Compatibility | Low VOC, tilt-up cure and | — | No cracking |
| with TPO | bondbreaker solvent and | | |
| membrane and | primer | | |
| Adhesive | | | |
| Chemical | No primer | ASTM D1876 | 2.01 N/mm |
| compatibility - | | | |
| T-peel to White | | | |
| Butyl Tape | | | |
| Chemical | Low VOC, tilt-up cure and | ASTM D1876 | 17.19 N/mm |
| compatibility - | bondbreaker solvent and | | |
| T-peel to White | primer | | |
| Butyl Tape | | | |
| Compatibility | Tested substrates: | Heat Aging Bleed | No cracking, no |
| with substrate | EPDM roofing membrane* (1); | Resistance test at | severe changes |
| | TPO roofing membrane* (2); | 80° C. at 4, 8, 12 week | observed |
| | EPDM accessory - EPDM | exposure, Example 8 | |
| | side* (3); | over a substrate | |
| | EPDM accessory - butyl side* | 2500 kj/m² UV | No cracking |
| | (4); | Exposure Bleed | |
| | TPO accessory - TPO side* | Resistance test at 4, 8, | |
| | (5) | 12 week exposure, | |
| | | Example 8 over a | |
| | | substrate | |

*Commercially available sample

(d) Example 6 was backed with an industry standard butyl roofing adhesive and tested according to ASTM D412A and ASTM D6290 to assess physical and colorimetric properties. Each test was conducted on three butyl-baked samples of Example 6 type compound. Testing was done on fresh samples or samples without aging and on samples after heat aging at 70° C. for 48 hours. The results are provided in Table 5 below.

TABLE 5
Physical and colorimetric properties of Example 6

| | | | |
|---|---|---|---|
| Measured Property | Testing Method | Unit | Result |

No heat aging

| | | | |
|---|---|---|---|
| Tensile Strength | ASTM D412A | MPa | 0.15-0.366 |
| Elongation at break | ASTM D412A | % | 1265-1610 |
| 100% Modulus | ASTM D412A | MPa | 0.14-0.21 |
| 100% Modulus at | ASTM D412A | MPa | 0.10 |
| 50 C. | | | |
| Color White - no | ASTM D6290 | — | L 91.88, a −0.89, |
| heat aging | | | b 2.24 |

Shelf Stability (heat aging at 70° C. for 48 hours)

| | | | |
|---|---|---|---|
| Tensile Strength | ASTM D412A | MPa | 0.23-0.53 |
| Elongation at break | ASTM D412A | % | 797-800+ |
| 100% Modulus | ASTM D412A | MPa | 0.12-0.17 |
| 100% Modulus at | ASTM D412A | MPa | 0.081-0.152 |
| 50 C. | | | |

### EXAMPLES 9-11

Examples 9-11 were prepared by homogenizing components listed in Table 6.

TABLE 6
Components and wt. % of components of Examples 9-11

| | Example no. | | |
|---|---|---|---|
| | 9 | 10 | 11 |
| Component | [wt. %] | [wt. %] | [wt. %] |
| Ethylene-1-butene copolymer (ML | — | 64.4 | 40.92 |
| 1 + 4/121 C.: 20, MFR | | | |
| (190 C., 2.16 KG): 1.2, Density: 0.862 | | | |
| g/cc, Shore A: 46) | | | |
| Ethylene-octene polyolefin | — | 23.0 | — |
| elastomer (Melt index | | | |
| (190 C., 2.16 KG): 3.0, Density: 0.902 | | | |
| g/cc, Shore A: 90, Melt Temp | | | |
| (DSC): 97° C.) | | | |
| Ethylene-octene polyolefin | 55.76 | — | — |
| elastomer (Melt index | | | |
| (190 C., 2.16 KG): 1.0, Density: 0.857 | | | |
| g/cc, Shore A: 54, Melt Temp | | | |
| (DSC): 38° C.) | | | |
| Ethylene propylene copolymer (MFR | 12.3 | 2.76 | 7.35 |
| (230 C., 2.16 KG): 25, Density: 0.868 | | | |
| g/cc, Shore A: 84, Total crystallinity: | | | |
| 16%) | | | |
| Olefin block copolymer (Melt index | 12.3 | — | — |
| (190 C., 2.16 KG): 15, Density: 0.877 | | | |
| g/cc, Shore A: 55, Melt Temp | | | |
| (DSC): 118° C.) | | | |
| Titanium dioxide | 6.84 | 3.04 | 4.18 |
| Dewaxed white paraffinic oil | — | — | 40.0 |
| Random copolymer of Ethylene and | 7.76 | 3.45 | 4.73 |
| Butyl Acrylate | | | |
| Pelletized silicone gum | 0.90 | 0.40 | 0.55 |
| Antioxidant | 0.25 | 0.11 | 0.15 |
| Light stabilizer including hindered | 2.25 | 1.0 | 1.38 |
| amines | | | |
| Silane composition | 1.64 | 1.84 | 0.74 |

Examples 9-11 were tested for tensile strength and elongation at break. Results are listed below in Table 7.

TABLE 7
Physical properties of Example 9-11

| | | Example no. | | |
|---|---|---|---|---|
| | Testing | 9 | 10 | 11 |
| Measured property | Method | [wt. %] | [wt. %] | [wt. %] |
| Tensile Strength [MPa] | ASTM D412 A | 4.59 | 10.02 | 0.47 |
| Elongation at Break [%] | ASTM D412 A | 1004 | 771 | 1005.0 |

As can be seen in Table 7, Examples 9 and 10 had a greater tensile strength than is desirable for the accessory application. The high tensile strength of Examples 9 and 10 indicated a material of insufficient pliability. Example 11 exhibited good tensile strength as well as elongation at break, suitable for the accessory application.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A roofing membrane accessory comprising:
an elastomeric layer including non-crosslinked elastomeric material, the elastomeric layer having a composition including:
(B) 100 PHR of a base polymer including ethylene propylene diene monomers (EPDM) with a sum of ethylidene norbornene (ENB) content, vinyl norbornene (VNB) content, norbornadiene content, and 1,4 hexadiene content and/or dicyclopentadiene (DCPD) content from about 0 to 9 wt. %,
(B) about 50 to 300 PHR of calcium carbonate; and
(C) about 50 to 200 PHR of dewaxed heavy paraffinic process oil(s);
a butyl-based layer adjacent to the elastomeric layer; and
a protective layer configured as a liner, the protective layer arranged adjacent to the butyl-based layer such that the butyl-based layer is interposed between the elastomeric layer and protective layers, the roofing membrane accessory having elongation at break of about 400% to 2200%.

2. The roofing membrane accessory of claim 1 wherein the sum of ethylidene norbornene (ENB) content, vinyl norbornene (VNB) content, norbornadiene content, and 1,4 hexadiene content and dicyclopentadiene (DCPD) is about 2 to 8.7 wt. %.

3. The roofing membrane accessory of claim 1 wherein base polymer including ethylene propylene diene monomers (EPDM) has a ethylidene norbornene (ENB) content from about 0 to 9 wt. %

4. The roofing membrane accessory of claim 1 wherein the final level of crosslinking is no more than about 15%.

5. The roofing membrane accessory of claim 1 wherein the roofing membrane accessory has a tensile strength of about 0.14 to 0.80 MPa according to ASTM D412 A.

6. The roofing membrane accessory of claim 1 wherein the calcium carbonate is present at 80 to 220 PHR.

7. The roofing membrane accessory of claim 1 wherein the base polymer has an ethylene content of about 48 to 75 wt. %.

8. The roofing membrane accessory of claim 1 wherein the roofing membrane accessory remains in an uncured non-crosslinked state at least for a time period after installation.

9. A roofing membrane accessory comprising:
a non-crosslinked elastomeric material having a composition including:
(A) 40 to 200 PHR of a base polymer including ethylene propylene diene monomer (EPDM) having a sum of ethylidene norboniene (ENB) content, vinyl norboniene (VNB) content, norbornadiene content, and 1,4 hexadiene content and/or dicyclopentadiene (DCPD) content from about 0 to 9 wt. %,
(B) (B) about 50 to 300 PHR of calcium carbonate;
(C) about 50 to 200 PHR of a dewaxed heavy paraffinic process oil(s); and
(D) about 10 to 40 PHR of a silane-grafted elastomer,
the non-crosslinked elastomeric material being free of a crosslinking catalyst and having Mooney viscosity (1+4 at 100° C.) of about 10 to 60.

10. The roofing membrane accessory of claim 9 wherein the EPDM is present at 100 PHR.

11. The roofing membrane accessory of claim 9 wherein base polymer including ethylene propylene diene monomers (EPDM) has a ethylidene norbornene (ENB) content from about 0 to 9 wt %.

12. The roofing membrane accessory of claim 9 wherein the sum of ethylidene norbornene (ENB) content, vinyl norbornene (VNB) content, norbornadiene content, and/or 1,4 hexadiene content and dicyclopentadiene (DCPD) content is from 4.5 to 6 wt. %.

13. The roofing membrane accessory of claim 9 wherein base polymer including ethylene propylene diene monomers (EPDM) has a ethylidene norbornene (ENB) content from about 0 to 9 wt %.

14. The roofing membrane accessory of claim 9 wherein the silane-grafted elastomer include a silane-grafted polymer or copolymer of an olefin selected from the group consisting of aliphatic C₂-C₂₀ α-olefins.

15. The roofing membrane accessory of claim 14 wherein the aliphatic C₂-C₂₀ α-olefins are selected from the group consisting of ethylene, propylene, 1-butene, 4-methyl-1-pentene, 1-hexene, 1-octene, 1-decene, 1-dodecene, 1-tetradecene, 1-hexadecene, 1-octadecene and 1-eicosene.

16. The roofing membrane accessory of claim 15 wherein the silane-grafted elastomer is catalyst free.

17. The roofing membrane accessory of claim 9 wherein the silane-grafted elastomer include a silane-grafted copolymer of an olefin selected from the group consisting of ethylene-1-butene copolymer, ethylene propylene copolymer, ethylene/α-olefin copolymer, propylene/α-olefin copolymer, or a combination thereof.

18. A roofing accessory comprising:
100 PHR of a base polymer,
about 50 to 300 PHR of calcium carbonate;
about 50 to 200 PHR of a dewaxed heavy paraffinic process oil(s); and
about 6 to 20 PHR a titanium dioxide,
the roofing accessory having a colorimetric brightness value L* of about 96.5 to 98 and tone value b* of about 1.5 to 2.5, measured according to D.

19. The roofing accessory of claim 18 wherein the base polymer includes ethylene propylene diene monomer (EPDM) having a sum of ethylidene norbornene (ENB) content, vinyl norbornene (VNB) content, norbornadiene content, and 1,4 hexadiene content and/or dicyclopentadiene (DCPD) content from about 0 to 9 wt. %.

20. The roofing accessory of claim 18 wherein base polymer including ethylene propylene diene monomers (EPDM) has a ethylidene norbornene (ENB) content from about 0 to 9%.

21. The roofing accessory of claim 18 wherein the base polymer includes an olefin block copolymer free of diene units formed from polymerization of ethylene or propylene monomers with an aliphatic C₂-C₂₀ α-olefin.

22. The roofing accessory of claim 21 wherein the aliphatic C₂-C₂₀ α-olefin is selected from the group consisting of ethylene, propylene, 1-butene, 4-methyl-1-pentene, 1-hexene, 1-octene, 1-decene, 1-dodecene, 1-tetradecene, 1-hexadecene, 1-octadecene and 1-eicosene.

23. The roofing accessory of claim 18 wherein the roofing accessory is free of a catalyst and/or curative.

24. The roofing accessory of claim 18 wherein the base polymer includes ethylene propylene rubber.
